(19) United States
(12) Patent Application Publication
(10) Pub. No.: US 2022/0220416 A1
(43) Pub. Date: Jul. 14, 2022

(54) FABRIC CONDITIONING COMPOSITION

(71) Applicant: RHODIA OPERATIONS, Aubervilliers (FR)

(72) Inventors: Rita AHUJA, Singapore (SG); Yi Ling LOW, Singapore (SG)

(21) Appl. No.: 17/610,554

(22) PCT Filed: May 12, 2020
(86) PCT No.: PCT/EP2020/063243

§ 371 Date: Nov. 11, 2021

(30) Foreign Application Priority Data
May 21, 2019 (EP) EP2019/063135

(51) Int. Cl. C11D 1/62; C11D 3/00; C11D 3/22; C11D 3/382; C11D 3/30; C11D 1/835; C11D 11/00

(52) U.S. Cl. CPC C11D 1/62; C11D 3/0015; C11D 3/222; C11D 11/0017; C11D 3/30; C11D 1/835; C11D 3/382

(57) ABSTRACT

The present invention relates to a composition comprising a quaternary ammonium compound, a cationic polysaccharide, a non-ionic polysaccharide and a vegetable oil. The composition can notably be used for conditioning fabrics.

This application claims priority filed on 21 May 2019 in INTERNATIONAL PROCEDURE with Nr EP2019/063135, the whole this application being incorporated herein by reference for all purposes.

### TECHNICAL FIELD

The present invention relates to a composition, in particular a fabric conditioning composition, comprising a quaternary ammonium compound, a cationic polysaccharide, a non-ionic polysaccharide and a vegetable oil. The present invention also relates to a method of use of the composition, in particular a method for treating fabrics.

### BACKGROUND ART

Fabric conditioning compositions are often used in rinse cycle of the laundering process to soften fabrics and to impart them nice smell. Generally, fabric conditioning systems are based on quaternary ammonium compounds (“quats”). Advantageously, ester quats can be used as the fabric conditioning actives. One advantage of ester quats is that they are bio-degradable and exhibit lower eco toxicity, which are highly desired characteristics in light of environment concerns.

Ideally, fabric conditioning compositions should have good softening performance, excellent capacity of depositing benefit agents (e.g. perfumes) to fabrics, as well as good stability. Stability is very important as compositions with poor stability may become unpourable and have inadequate dispensing and dissolving characteristics in rinse water. Methods have been developed to enhance stability of fabric conditioning compositions. One option is to lower the quats content in the compositions by replacing part of the quats with a cationic polymer, such as a cationic polysaccharide. Reduction of the quat content is also of interest for cost considerations.

Addition of cationic polymers to fabric conditioning compositions also has a variety of benefits. U.S. Pat. No. 6,492,322 discloses fabric softening compositions comprising biodegradable di-ester softening compounds and cationic polymers including polysaccharides, such as gums, starches and certain cationic synthetic polymers. PCT patent publication no. WO2015/192971 discloses softening compositions containing an ester quat, a cationic polysaccharide and a non-ionic polysaccharide. The disclosed compositions have good softening performance and good perfume delivery capacity.

That being said, including quats and cationic polysaccharides in the same composition will lead to certain problems. Specifically, quats and cationic polysaccharides, when used in combination, tend to phase separate. As a result, the composition is no longer homogeneous and segregates into different phases. This phenomenon may pose difficulties to consumers and may affect retailers when they place products on the shelves, without mentioning any associated loss of performance of the softening products.

Thus, it remains a challenge to provide a fabric conditioning composition having excellent softening performance combined with good stability. It remains a challenge to provide a fabric conditioning composition which can have long shelf life, and can remain homogenous for extended time. In particular, it remains a challenge to provide a fabric conditioning composition with good stability without jeopardizing the dispersibility of the composition in aqueous solutions.

### SUMMARY OF INVENTION

It has been found that the above problems can be solved by the present invention.

In a first aspect, the present invention relates to a composition comprising (a) a quaternary ammonium compound; (b) a cationic polysaccharide; (c) a non-ionic polysaccharide; and (d) a vegetable oil.

The quaternary ammonium compound may be an alkyl quat. Alternatively the quat may contain at least an ester group, such as a di-ester quat.

The cationic polysaccharide may notably be a cationic guar.

The non-ionic polysaccharide may notably be a non-ionic guar.

The vegetable oil is preferably selected from sunflower oil, olive oil and almond oil, in particular sunflower oil.

In a second aspect of the present invention, there is provided a method for treating a fabric, such as for conditioning a fabric, wherein the method comprises a step of contacting the fabric with a composition comprising: (a) a quaternary ammonium compound; (b) a cationic polysaccharide; (c) a non-ionic polysaccharide; and (d) a vegetable oil.

In a third aspect of the present invention, there is provided a use of a composition for conditioning a fabric, wherein the composition comprises: (a) a quaternary ammonium compound; (b) a cationic polysaccharide; (c) a non-ionic polysaccharide; and (d) a vegetable oil.

It has been found that the composition according to the present invention provides excellent softening performance on fabrics. The composition also has good storage stability. Furthermore, it has been found that the composition can perform well under different conditions of the laundry operation.

Other advantages and more specific properties of the composition according to the present invention will be clear after reading the following description of the invention.

### DETAILED DESCRIPTION

Throughout the description, including the claims, the term “comprising one” or “comprising a” should be understood as being synonymous with the term “comprising at least one”, unless otherwise specified, and “between” should be understood as being inclusive of the limits.

It should be noted that in specifying any range of concentration, weight ratio or amount, any particular upper concentration, weight ratio or amount can be associated with any particular lower concentration, weight ratio or amount, respectively.

In the context of this invention, the term “fabric conditioning” is used herein the broadest sense to include any conditioning benefit(s) to textile fabrics, materials, yarns, and woven fabrics. One such conditioning benefit is softening fabrics. Other non-limiting conditioning benefits include fabric lubrication, fabric relaxation, durable press, wrinkle resistance, wrinkle reduction, ease of ironing, abrasion resistance, fabric smoothing, anti-felting, anti-pilling, crispness, appearance enhancement, appearance rejuvenation, color protection, color rejuvenation, anti-shrinkage, in-wear shape retention, fabric elasticity, fabric tensile strength, fabric tear strength, static reduction, water absorbency or repellency, stain repellency; refreshing, anti-microbial, odor resistance; perfume freshness, perfume longevity, and mixtures thereof.

As used herein, the term “alkyl” means a saturated hydrocarbon radical, which may be straight, branched or cyclic, such as, methyl, ethyl, n-propyl, iso-propyl, n-butyl, sec-butyl, t-butyl, pentyl, n-hexyl, cyclohexyl.

As used herein, the term “alkenyl” as a group or part of a group denotes an aliphatic hydrocarbon group containing at least one carbon-carbon double bond and which may be straight or branched. The group may contain a plurality of double bonds in the normal chain and the orientation about each is independently E or Z. Exemplary alkenyl groups include, but are not limited to, ethenyl, propenyl, butenyl, pentenyl, hexenyl, heptenyl, octenyl and nonenyl. The group may be a terminal group or a bridging group.

As used herein, the term “hydroxyalkyl” means an alkyl radical, which is substituted with a hydroxyl groups, such as hydroxymethyl, hydroxyethyl, hydroxypropyl, and hydroxydecyl.

The term “cationic polymer” as used herein means any polymer which has a cationic charge.

The term “quaternary ammonium compound” (also referred to as “quat”) as used herein means a compound containing at least one quaternized nitrogen wherein the nitrogen atom is attached to four organic groups. The quaternary ammonium compound may comprise one or more quaternized nitrogen atoms.

The term “cationic polysaccharide” as used herein means a polysaccharide or a derivative thereof that has been chemically modified to provide the polysaccharide or the derivative thereof with a net positive charge in a pH neutral aqueous medium. The cationic polysaccharide may also include those that are non-permanently charged, e.g. a derivative that can be cationic below a given pH and neutral above that pH. Non-modified polysaccharides, such as starch, cellulose, pectin, carageenan, guars, xanthans, dextrans, curdlans, chitosan, chitin, and the like, can be chemically modified to impart cationic charges thereon. A common chemical modification incorporates quaternary ammonium substituents to the polysaccharide backbones. Other suitable cationic substituents include primary, secondary or tertiary amino groups or quaternary sulfonium or phosphinium groups. Additional chemical modifications may include cross-linking, stabilization reactions (such as alkylation and esterification), phophorylations, hydrolyzations.

The term “non-ionic polysaccharide” as used herein refers to a polysaccharide or a derivative thereof that has been chemically modified to provide the polysaccharide or the derivative thereof with a net neutral charge in a pH neutral aqueous medium; or a non-modified polysaccharide.

The term “first rinse”, as used herein, means a step of rinsing fabrics which is conducted subsequent to the laundering of the fabrics, without any additional rinsing of the fabrics in between. The first rinse may be a rinsing cycle of an automated or non-automated washing machine. Alternatively, the first rinse may be a hand rinsing process subsequent to the laundering of the fabrics.

The term “rinse solution”, as used herein, means a solution, notably an aqueous solution, used to rinse fabrics after the fabrics have been laundered. The rinse solution may be used in an automated or non-automated washing machine, or in the case of hand washing, may be used in a simple container, such as a basin or bucket.

The term “laundry residue”, as used herein, means any material that may be present either on fabrics or in the detergent liquid during the wash cycle of the laundry operation and that is carried over with laundered fabrics to the rinse solution. Thus, “laundry residue” includes but is not limited to, residual soils, particulate matter, detergent surfactants, detergent builders, bleaching agents, metal ions, lipids, enzymes and any other materials that may have been present in the wash cycle solution. Furthermore, excess wash cycle solutions may be squeezed, wrung, or spun out of fabrics to remove excess laundry residue, prior to adding the fabrics to the rinse solution. However, such laundry residue is not completely removed (i.e., rinsed out of the fabrics with water) prior to adding the fabrics to the rinse solution. Preferably, laundry residue includes “surfactant residue”, which means a surfactant material that may be present either on the fabrics or in the detergent liquid during the wash cycle of the laundry process and that is carried over with the laundered fabrics into the rinse solution.

In one aspect, the present invention relates to a composition, notably a fabric conditioning composition, which comprises (a) a quaternary ammonium compound; (b) a cationic polysaccharide; (c) a non-ionic polysaccharide; and (d) a vegetable oil.

The composition of the present invention is preferably an aqueous fabric conditioning composition. The composition may also be a home care composition having, among other properties, fabric conditioning properties, such as a detergent composition with conditioning properties.

Quaternary Ammonium Compound

According to the present invention, the quaternary ammonium compound may have the general formula (I):

[N⁺(R₁)(R₂)(R₃)(R₄)]_{y}X⁻ (I)

wherein:

R₁, R₂, R₃ and R₄, which may be the same or different, is a C₁-C₄₀ hydrocarbon group, respectively, optionally containing a heteroatom or an ester or amide group;

X is an anion, for instance, a halide such as Cl or Br, sulphate, alkyl sulphate, nitrate and acetate;

y is the valence of X.

For instance, R₁, R₂, R₃ and R₄ is, respectively, a C₁-C₄₀ alkyl, alkenyl, hydroxyalkyl, or ethoxylated alkyl group. Alternatively, R₁, R₂, R₃ and R₄ is, respectively, a C₁-C₄₀ hydrocarbon group containing a heteroatom or an ester or amide group.

In some aspects, the quaternary ammonium compound is an alkyl quat, such as a di-alkyl quat. The quat may notably be a compound of general formula (II):

[N⁺(R₅)₂(R₆)(R₇)]_{y}X⁻ (II)

wherein:

R₅ is a C₁₆-C₂₂ alkyl, alkenyl or hydroxyalkyl group;

R₆ is a C₁-C₄ alkyl, alkenyl or hydroxyalkyl group;

R₇ is R₅ or R₆;

X is an anion, for example halide such as Cl or Br, sulphate, alkyl sulphate, nitrate or acetate;

y is the valence of X.

One example of the alkyl quat is dihydrogenated tallow dimethyl ammonium chloride.

In some aspects, at least one of R₁, R₂, R₃ and R₄ as defined in general formula (I) contains an ester or amide group. Accordingly, the quaternary ammonium compound is an ester quat such as a di-alkyl di-ester quat. Advantageously, the quat has the general formula (III):

[N⁺((CH₂)ₙ-T-R₈)ₘ(R₉)₄₋ₘ]_{y}X⁻ (III)

wherein:

R₈ is a C₁-C₂₄ alkyl, alkenyl, or hydroxylalkyl group;

R₉ is a C₁-C₄ alkyl, alkenyl, or hydroxylalkyl group;

T is —C(═O)—O—, —O—C(═O)—, —NR₁₀—C(═O)— or —(C═O)—NR₁₀—, wherein

R₁₀ is hydrogen, a C₁-C₆ alkyl, alkenyl, or hydroxyalkyl group;

n is an integer from 0 to 5;

m is selected from 1, 2 and 3;

X is an anion, for example a chloride, bromide, nitrate or methosulphate ion;

y is the valence of X.

In one exemplary embodiment, T as defined in general formula (III) is —C(═O)—O— or —O—C(═O)—.

Preferably, m as defined in general formula (III) is 2. Accordingly, the quaternary ammonium compound may have the general formula of (IV):

[N⁺((CH₂)ₙ-T-R₈)₂(R₉)₂]_{y}X⁻ (IV)

wherein R₈, R₉, T, n, y and X are as defined in general formula (III).

In one exemplary embodiment, T as defined in general formula (IV) is —C(═O)—O— or —O—C(═O)—.

Preferably, the average chain length of the fatty acid chains is at least C₁₄, more preferably at least C₁₆. Even more preferably at least half of the chains have a length of C₁₈. For example, the fatty acid chains of the ester quat suitable for the invention may comprise from 20 to 35 weight percent of saturated C₁₈ chains and from 20 to 35 weight percent of monounsaturated C₁₈ chains by weight of total fatty acid chains. Preferably, the ester quat is derived from palm or tallow feedstocks. These feedstocks may be pure or predominantly palm or tallow based. Blends of different feedstocks may be used. In one embodiment, the fatty acid chains of the ester quat comprise from 25 to 30 weight percent, preferably from 26 to 28 weight percent of saturated C₁₈ chains and from 25 to 30 weight percent, preferably from 26 to 28 weight percent of monounsaturated C₁₈ chains, by weight of total fatty acid chains. In another embodiment, the fatty acid chains of the ester quat comprise from 30 to 35 weight percent, preferably from 33 to 35 weight percent of saturated C₁₈ chains and from 24 to 35 weight percent, preferably from 27 to 32 weight percent of monounsaturated C₁₈ chains, by weight of total fatty acid chains. The fatty acid chains may be predominantly linear, although a degree of branching, especially mid-chain branching, is within the scope of the invention.

According to every one of the invention embodiments, the quat is preferably a triethanolamine-based quaternary ammonium of general formula (V)

[N⁺(C₂H₄—OOCR₁₁)₂(CH₃)(C₂H₄—OH)](CH₃)_{z}SO₄⁻ (V)

wherein R₁₁ is a C₁₂-C₂₀ alkyl, alkenyl, or hydroxyalkyl group;
z is an integer from 1 to 3.

The quaternary ammonium compound may also be a mixture of various quaternary ammonium compounds, notably a mixture of mono-, di- and tri-ester components or a mixture of mono-, and di-ester components, wherein for instance the amount of di-ester quaternary is comprised between 30 and 99% by weight based on the total amount of the quaternary ammonium compound.

Advantageously, the quaternary ammonium compound is a mixture of mono-, di- and tri-ester components, wherein:
the amount of di-ester quaternary is comprised between 30 and 70% by weight based on the total amount of the quaternary ammonium compound, preferably between 40 and 60% by weight,
the amount of mono-ester quaternary is comprised between 10 and 60% by weight based on the total amount of the quaternary ammonium compound, preferably between 20 and 50% by weight,
the amount of tri-ester quaternary is comprised between 1 and 20% by weight based on the total amount of the quaternary ammonium compound.

Alternatively, the quaternary ammonium compound is a mixture of mono- and di-ester components, wherein:
the amount of di-ester quaternary is comprised between 30 and 99% by weight based on the total amount of the quaternary ammonium compound, preferably between 50 and 99 by weight,
the amount of mono-ester quaternary is comprised between 1 and 50% by weight based on the total amount of the quaternary ammonium compound, preferably between 1 and 20% by weight.

Very preferred quaternary ammonium compounds, for example, include:

TET: Di(tallowcarboxyethyl)hydroxyethyl methyl ammonium methylsulfate,

TEO: Di(oleocarboxyethyl)hydroxyethyl methyl ammonium methylsulfate,

TES: Distearyl hydroxyethyl methyl ammonium methylsulfate,

TEHT: Di(hydrogenated tallow-carboxyethyl)hydroxyethyl methyl ammonium methylsulfate,

TEP: Di(palmiticcarboxyethyl)hydroxyethyl methyl ammonium methylsulfate,

DEEDMAC: Dimethylbis[2-[(1-oxooctadecyl)oxy]ethyl]ammonium chloride.

In one exemplary embodiment, the quaternary ammonium compound is bis-(2-hydroxypropyl)-dimethylammonium methylsulphate fatty acid ester having a molar ratio of fatty acid moieties to amine moieties of from 1.5 to 1.99, an average chain length of the fatty acid moieties of from 16 to 18 carbon atoms and an iodine value of the fatty acid moieties, calculated for the free fatty acid, of from 0.5 to 60, and from 0.5 to 5% by weight fatty acid. Preferably, the bis-(2-hydroxypropyl)-dimethylammonium methylsulphate fatty acid ester is a mixture of at least one di-ester of formula

[(CH₃)₂N⁺(CH₂CH(CH₃)OC(═O)R₁₂)₂]CH₃SO₄⁻ (VI)

and at least one mono-ester of formula:

[(CH₃)₂N⁺(CH₂CH(CH₃)OH)(CH₂CH(CH₃)OC(═O)R₁₂)]CH₃SO₄⁻ (VII)

wherein R₁₂ is the hydrocarbon group of a fatty acid moiety R₁₂COO—. Notably, such bis-(2-hydroxypropyl)-dimethylammonium methylsulphate fatty acid ester has a molar ratio of fatty acid moieties to amine moieties of from 1.85 to 1.99, the fatty acid moiety has an average chain length of from 16 to 18 carbon atoms and an iodine value, calculated for the free fatty acid, of from 0.5 to 60, preferably from 0.5 to 50. The average chain length is preferably from 16.5 to 17.8 carbon atoms. The iodine value is preferably from 5 to 40, more preferably, from 15 to 35. The iodine value is the amount of iodine in g consumed by the reaction of the double bonds of 100 g of fatty acid, which may notably be determined by the method of ISO 3961. In order to provide the required average chain length and iodine value, the fatty acid moiety may be derived from a mixture of fatty acids comprising both saturated and unsaturated fatty acids.

In another exemplary embodiment, the quaternary ammonium compound is a compound of the general formula

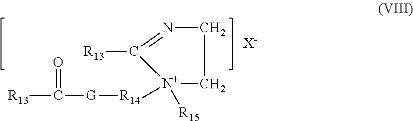

wherein R₁₅ is either hydrogen, a short chain C₁-C₆, preferably C₁-C₃ alkyl or hydroxyalkyl group, poly(C₂-C₃ alkowy), preferably polyethoxy, benzyl, or mixtures thereof;

R₁₃ is a hydrocarbyl, or substituted hydrocarbyl group;

X⁻ have the definitions given above;

R₁₄ is a C₁-C₆ alkylene group, preferably an ethylene group; and

G is an oxygen atom, or an —NR₁₀— group wherein R₁₀ is as defined above.

A non-limiting example of compound (VIII) is 1-methyl-1-stearoylamidoethyl-2-stearoylimidazolinium methylsulfate.

In still another exemplary embodiment, the quaternary ammonium compound is a compound of the general formula (IX):

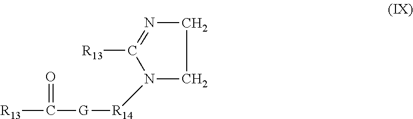

wherein R₁₃, R₁₄ and G are defined as above.

In still another exemplary embodiment, the quaternary ammonium compound is a compound of the general formula (X):

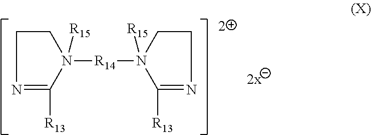

wherein R₁₃, R₁₄ and R₁₅ are defined as above.

A non-limiting example of compound (X) is

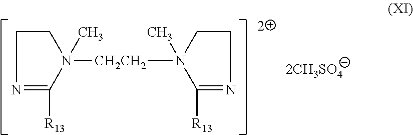

wherein R₁₃ is defined as above.

The quaternary ammonium compound may be present in an amount of from

0.5 to 45 wt % based on the total weight of the composition, for instance from

0.5 to 10 wt % based on the total weight of the composition, for instance from

2 to 8 wt % based on the total weight of the composition, for instance from

2.5 to 6 wt % based on the total weight of the composition.

Cationic Polysaccharide

The composition comprises a cationic polysaccharide, or a mixture of cationic polysaccharides. The cationic polysaccharide can be obtained by chemically modifying polysaccharides (generally natural polysaccharides).

By such modification, cationic side groups, such as quaternary ammonium groups, can be introduced into the polysaccharide backbone.

The cationic polysaccharides suitable for the present invention include but are not limited to:

cationic cellulose and derivatives thereof, cationic starch and derivatives thereof, cationic callose and derivatives thereof, cationic xylan and derivatives thereof, cationic mannan and derivatives thereof, cationic galactomannan and derivatives thereof, such as cationic guar and derivatives thereof.

The cationic celluloses may be cellulose ethers comprising quaternary ammonium groups, cationic cellulose copolymers or celluloses grafted with a water-soluble quaternary ammonium monomer. Examples of cellulose ethers include those sold under the names “JR” (JR 400, JR 125, JR 30M) or “LR” (LR 400, LR 30M) by the Dow Company. These polymers are also defined in the CTFA dictionary as hydroxyethylcellulose quaternary ammoniums that have reacted with an epoxide substituted with a trimethylammonium group. Suitable cationic celluloses also include LR3000 KC from the Solvay Company.

The cationic cellulose copolymers or the celluloses grafted with a water-soluble quaternary ammonium monomer may be those described in U.S. Pat. No. 4,131,576, such as hydroxyalkylcelluloses, for instance hydroxymethyl-, hydroxyethyl- or hydroxypropylcelluloses grafted especially with a methacryloyl-ethyltrimethylammonium, methacrylamidopropyltrimethylammonium or dimethyl-diallylammonium salt. The commercial products corresponding to this definition are more particularly the products sold under the names Celquat® L 200 and Celquat® H 100 by the Akzo Nobel Company.

Cationic starches suitable for the present invention include the products sold under Polygelo® (cationic starches from Sigma), the products sold under Softgel®, Amylofax® and Solvitose® (cationic starches from Avebe), CATO from the National Starch Company.

Suitable cationic galactomannans can be those derived from Fenugreek Gum, Konjac Gum, Tara Gum, Cassia Gum or Guar Gum.

According to every one of the invention embodiments, the cationic polysaccharide is preferably a cationic guar. Guars are polysaccharides composed of the sugars galactose and mannose. The backbone is a linear chain of β 1,4-linked mannose residues to which galactose residues are 1,6-linked at every second mannose in average, forming short side units. Within the context of the present invention, the cationic guars are cationic derivatives of guars.

In the case of cationic polysaccharides, such as cationic guars, the cationic group may be a quaternary ammonium group bearing 3 radicals, which may be identical or different, preferably chosen from hydrogen, alkyl, hydroxyalkyl, epoxyalkyl, alkenyl, or aryl, preferably containing 1 to 22 carbon atoms, more particularly 1 to 14 and advantageously 1 to 3 carbon atoms. The counterion is generally a halogen. One example of the halogen is chlorine. Examples of the quaternary ammonium group include: 3-chloro-2-hydroxypropyl trimethyl ammonium chloride (CHPTMAC), 2,3-epoxypropyl trimethyl ammonium chloride (EPTAC), diallyldimethyl ammonium chloride (DMDAAC), vinylbenzene trimethyl ammonium chloride, trimethylammonium ethyl metacrylate chloride, methacrylamidopropyltrimethyl ammonium chloride (MAPTAC), and tetraalkylammonium chloride.

One example of the cationic functional group in the cationic polysaccharides is trimethylamino(2-hydroxyl)propyl, with a counter ion. Various counter ions can be utilized, including but not limited to halides, such as chloride, fluoride, bromide, and iodide, sulfate, nitrate, methylsulfate, and mixtures thereof.

The cationic guars suitable for the present invention may be chosen from: cationic hydroxyalkyl guars, such as cationic hydroxyethyl guar, cationic hydroxypropyl guar, cationic hydroxybutyl guar, and cationic carboxylalkyl guars including cationic carboxymethyl guar, cationic alkylcarboxy guars such as cationic carboxylpropyl guar and cationic carboxybutyl guar, cationic carboxymethylhydroxypropyl guar.

In one exemplary embodiment, the cationic polysaccharide is a guar hydroxypropyltrimonium chloride or a hydroxypropyl guar hydroxypropyltrimonium chloride.

The cationic polysaccharides, such as the cationic guars, may have an weight average molecular weight (Mw) of between 100,000 Daltons and 3,500,000 Daltons, preferably between 100,000 Daltons and 1,500,000 Daltons.

The composition may comprise from 0.05 to 10 wt % of the cationic polysaccharide based on the total weight of the composition, for instance from 0.05 to 5 wt % based on the total weight of the composition, for instance from 0.2 to 2 wt % based on the total weight of the composition.

In the context of the present application, the term “Degree of Substitution (DS)” of cationic polysaccharides, such as cationic guars, is the average number of hydroxyl groups substituted per sugar unit. DS may notably represent the number of the carboxymethyl groups per sugar unit. DS may be determined by titration.

The DS of the cationic polysaccharide, such as the cationic guar, may be in the range of 0.01 to 1, for instance in the range of 0.05 to 1, for instance in the range of 0.05 to 0.2.

In the context of the present application, “Charge Density (CD)” of cationic polysaccharides, such as cationic guars, means the ratio of the number of positive charges on a monomeric unit of which a polymer is comprised to the molecular weight of said monomeric unit.

The CD of the cationic polysaccharide, such as the cationic guar, may be in the range of 0.1 to 3 meq/gm, for instance in the range of 0.1 to 2 meq/gm, for instance in the range of 0.1 to 1 meq/gm.

Non-Ionic Polysaccharide

The non-ionic polysaccharide according to the present invention can be a modified non-ionic polysaccharide or a non-modified non-ionic polysaccharide. The modified non-ionic polysaccharide may comprise hydroxyalkylation and/or esterification. In the context of the present application, the level of modification of non-ionic polysaccharides can be characterized by Molar Substitution (MS), which means the average number of moles of substituents, such as hydroxypropyl groups, per mole of the monosaccharide unit. MS can be determined by the Zeisel-GC method, notably based on the following literature reference: K. L. Hodges, W. E. Kester, D. L. Wiederrich, and J. A. Grover, “Determination of Alkoxyl Substitution in Cellulose Ethers by Zeisel-Gas Chromatography”, Analytical Chemistry, Vol. 51, No. 13, November 1979. When using this method the following gas chromatograph conditions can be used:

Column: DB-1 (30 m×0.32 mm ID×1.0 μm film thickness),

Program: 75° C.-300° C. at 25° C./min (hold at 75° C. for 5 minutes),

Detector: Flame Ionization,

Injector/Detector Temperature: 250/320° C.,

Carrier gas Flow: Helium-1 ml/min,

Split flow: Helium-20 ml/min, and

Injection volume: 1 microliter.

The MS of the non-ionic polysaccharide may be in the range of 0 to 3, for instance in the range of 0.1 to 3.

The non-ionic polysaccharide may be especially chosen from glucans, modified or non-modified starches (such as those derived, for example, from cereals, for instance wheat, corn or rice, from vegetables, for instance yellow pea, and tubers, for instance potato or cassava), amylose, amylopectin, glycogen, dextrans, celluloses and derivatives thereof (methylcelluloses, hydroxyalkylcelluloses, ethylhydroxyethylcelluloses), mannans, xylans, lignins, arabans, galactans, galacturonans, chitin, chitosans, glucuronoxylans, arabinoxylans, xyloglucans, glucomannans, pectic acids and pectins, arabinogalactans, carrageenans, agars, gum arabics, gum tragacanths, ghatti gums, karaya gums, carob gums, galactomannans such as guars and non-ionic derivatives thereof (hydroxypropyl guar), and mixtures thereof.

Among the celluloses that are especially used are hydroxyethylcelluloses and hydroxypropylcelluloses. Mention may be made of the products sold under the names Klucel® EF, Klucel® H, Klucel® LHF, Klucel® MF and Klucel® G by the Aqualon Company, and Cellosize® Polymer PCG-10 by the Amerchol Company, and HEC, HPMC K200, HPMC K35M by the Ashland Company.

According to every one of the invention embodiments, the non-ionic polysaccharide is preferably a non-ionic guar, which can be modified or non-modified. Suitable non-modified non-ionic guars include the products sold under the name Vidogum® GH 175 by the Unipectine Company and under the names Meypro®-Guar 50 and Jaguar© C by the Solvay Company. The modified non-ionic guars are especially modified with C₁-C₆ hydroxyalkyl groups. Among the hydroxyalkyl groups that may be mentioned, for example, are hydroxymethyl, hydroxyethyl, hydroxypropyl and hydroxybutyl groups. These guars are well known in the prior art and can be prepared, for example, by reacting the corresponding alkene oxides such as, for example, propylene oxides, with the guar so as to obtain a guar modified with hydroxypropyl groups.

The non-ionic polysaccharide may have a weight average molecular weight (Mw) of between 100,000 Daltons and 3,500,000 Daltons, preferably between 500,000 Daltons and 3,500,000 Daltons.

The composition may comprise from 0.05 to 10 wt % of the non-ionic polysaccharide based on the total weight of the composition, for instance from 0.05 to 5 wt % based on the total weight of the composition, for instance from 0.2 to 2 wt % based on the total weight of the composition.

The weight ratio between the quaternary ammonium compound and the total polysaccharides comprised in the composition may be between 2:1 and 100:1, preferably between 5:1 and 30:1.

The weight ratio between the cationic polysaccharide and the non-ionic polysaccharide comprised in the composition may be between 1:10 and 10:1, preferably between 1:3 and 3:1.

Vegetable Oil

The vegetable oils suitable for the present invention is typically an oil derived from a plant, for example, oils from seeds or fruits. Non-limiting examples of vegetable oils include sunflower oil, coconut oil, soybean oil, canola oil, rapeseed oil, corn oil, cottonseed oil, olive oil, palm oil, peanut oil, safflower oil, sesame oil, linseed oil, palm kernel oil, tung oil, jatropha oil, mustard oil, camelina oil, pennycress oil, castor oil, wheatgerm oil, apricot kernel oil, pistachio oil, poppy oil, pine oil, avocado oil, hazel nut oil, grapeseed oil, colza oil, cade oil, peach kernel oil, coffee bean oil, jojoba oil, and a mixture thereof.

Alternatively, said vegetable oil may be a mixture of the mono- and di- and tri-esters of a fatty acid mixture and glycerine, wherein said fatty acid mixture has the same or substantially similar fatty acid composition as a plant-based oil, such as one of the above mentioned plant-based oils.

According to every one of the invention embodiments, the vegetable oil is preferably selected from sunflower oil, olive oil and almond oil, in particular sunflower oil.

Sunflower oil usually has a fatty acid composition of about 0.1 wt % laurinic acid, about 0.2 wt % myristinic acid, from about 4.0 to about 8.0 wt % palmitic acid, about 0.3 wt % palmitoleic acid, from about 3.0 to about 7.0 wt % stearic acid, from about 14.0 to about 39.4 wt % oleic acid, from about 60.0 to about 88.0 wt % linoleic acid, about 0.3 wt % linolenic acid, about 0.5 wt % arachidic acid, about 0.3 wt % gadoleinic acid and from about 0.3 to about 1.5 wt % behenic acid.

Olive oil is plant-based oil pressed from the pulp and from the kernel of olives. Olive oil usually contains fatty acids as a mixture of from about 64.0 to about 68.0 wt % oleic acid, from about 11.0 to about 16.0 wt % linoleic acid, from about 8.0 to about 10.0 wt % palmitic acid, from about 4.0 to about 6.0 wt % eicosaenic acid and from about 4.0 to about 6.0 wt % palmitoleic acid.

The name almond oil (Prunus amygdalus dulcis (Sweet Almond) Oil) means the plant-based oil, which is obtained from both the sweet (lat. dulcis) and also the bitter (lat. amarus) almonds (by employing cold-pressing, for example). The fatty acid mixture of almond oil typically contains about 0.1 wt % of saturated fatty acids with a chain length of less than about 16 carbon atoms, from about 4.0 to about 9.0 wt % palmitic acid, about 0.8 wt % palmitoleic acid, about 0.2 wt % margarine acid, about 3.0 wt % stearic acid, from about 62.0 to about 86.0 wt % oleic acid, from about 20.0 to about 30.0 wt % linoleic acid, about 0.4 wt % linolenic acid, about 0.2 wt % arachidic acid, about 0.3 wt % eicosenoic acid, about 0.2 wt % behenic acid and about 0.1 wt % erucic acid.

Every plant oil is exemplified by its content of various fatty acids within specific quantity ranges. Since plant-based oils are natural ingredients, the specified fatty acid quantities are subject to natural a fluctuation range, which can vary slightly depending on the origin or the oil and the prevailing environmental conditions. The usual quantity ranges are therefore given for all the fatty acids contained in the oil concerned. Of course, all specified weight percentages are added to a maximum of about 100 wt % in each special oil batch.

The vegetable oil may be present in an amount of from 0.1 to 5 wt %, based on the total weight of the composition, for instance from 0.5 to 5 wt %, for instance from 1 wt % to 3 wt %.

Advantageously, there is provided a composition, notably a fabric conditioning composition, which comprises (a) a quaternary ammonium compound; (b) a cationic polysaccharide; (c) a non-ionic polysaccharide; and (d) a vegetable oil; wherein the composition is substantially free or completely free of any silicone.

As used herein, the term “substantially free” when used with reference to the absence of silicone, means that the composition comprises less than 0.1 wt % of the silicone, more preferably less than 0.01 wt % of the silicone, based on the total weight of the composition. As used herein, the term “completely free” when used with reference to the absence of silicone (i.e., 0 wt % of the silicone), means that the composition comprises no silicone at all.

Vegetable oil may be included in the composition for enhanced stability or enhanced softening performance, among other benefits, without the need for silicones to be included in the composition. Silicones may cause environmental concerns, and are thus less favourable for certain applications.

Other Ingredients

When talking about fabric conditioning compositions, it is highly desirable that the compositions can impart fabrics, aside from softness and other conditioning benefits, pleasant odour. This will require the compositions to contain a fragrance material or perfume in an amount sufficient for imparting the odour to the fabrics after the treatment. In addition, it is highly desired that the fragrance material or perfume can be effectively deposited onto the fabrics and the odour provided by them can be of high intensity and be long lasting on the fabrics.

As used herein, the term “fragrance material or perfume” means any organic substance or composition which has a desired olfactory property and is essentially non-toxic. Such substances or compositions include all fragrance material and perfumes that are commonly used in perfumery or in household compositions (laundry detergents, fabric conditioning compositions, soaps, all-purpose cleaners, bathroom cleaners, floor cleaners) or personal care compositions. The compounds involved may be natural, semi-synthetic or synthetic in origin.

Preferred fragrance materials and perfumes may be assigned to the classes of substance comprising the hydrocarbons, aldehydes or esters. The fragrances and perfumes also include natural extracts and/or essences, which may comprise complex mixtures of constituents, i.e. fruits such as almond, apple, cherry, grape, pear, pineapple, orange, lemon, strawberry, raspberry and the like; musk, flower scents such as lavender, jasmine, lily, magnolia, rose, iris, carnation and the like; herbal scents such as rosemary, thyme, sage and the like; woodland scents such as pine, spruce, cedar and the like.

Non limitative examples of synthetic and semi-synthetic fragrance materials and perfumes are: 7-acetyl-1,2,3,4,5,6,7,8-octahydro-1,1,6,7-tetramethylnaphthalene, α-ionone, β-ionone, γ-ionone, α-isomethylionone, methylcedrylone, methyl dihydrojasmonate, methyl 1,6,10-trimethyl-2,5,9-cyclododecatrien-1-yl ketone, 7-acetyl-1,1,3,4,4,6-hexamethyltetralin, 4-acetyl-6-tert-butyl-1,1-dimethylindane, hydroxyphenylbutanone, benzophenone, methyl b-naphthyl ketone, 6-acetyl-1,1,2,3,3,5-hexamethylindane, 5-acetyl-3-isopropyl-1,1,2-,6-tetramethylindane, 1-dodecanal, 4-(4-hydroxy-4-methylpentyl)-3-cyclohex-ene-1-carboxaldehyde, 7-hydroxy-3,7-dimethyloctanal, 10-undecen-1-al, isohexenylcyclohexylcarboxaldehyde, formyltricyclodecane, condensation products of hydroxycitronellal and methyl anthranilate, condensation products of hydroxycitronellal and indole, condensation products of phenylacetaldehyde and indole, 2-methyl-3-(para-tert-butylphenyl)propionaldehyde, ethylvanillin, heliotropin, hexylcinnamaldehyde, amylcinnamaldehyde, 2-methyl-2-(isopropylphenyl)propionaldehyde, coumarin, γ-decalactone, cyclopentadecanolide, 16-hydroxy-9-hexadecenoic acid lactone, 1,3,4,6,7,8-hexahydro-4,6,6,7,8,8-hexamethylcyclopenta-g-benzopyran, β-naphthol methyl ether, ambroxane, dodecahydro-3a,6,6,9a-tetramethylnaphtho[2,1b]furan, cedrol, 5-(2,2,3-trimethylcyclopent-3-enyl)-3-methylpentan-2-ol, 2-ethyl-4-(2,2,3-trimethyl-3-cyclopenten-1-yl)-2-buten-1-ol, caryophyllene alcohol, tricyclodecenyl propionate, tricyclodecenyl acetate, benzyl salicylate, cedryl acetate, and tert-butylcyclohexyl acetate.

Particular preference is given to the following:

hexylcinnamaldehyde, 2-methyl-3-(tert-butylphenyl)propionaldehyde, 7-acetyl-1,2,3,4,5,6,7,8-octahydro-1,1,6,7-tetramethylnaphthalene, benzyl salicylate, 7-acetyl-1,1,3,4,4,6-hexamethyltetralin, para-tert-butylcyclohexyl acetate, methyl dihydrojasmonate, (β-naphthol methyl ether, methyl g-naphthyl ketone, 2-methyl-2-(para-isopropylphenyl)propionaldehyde, 1,3,4,6,7,8-hexahydro-4,6,6,7,8,8-hexamethylcyclopenta-g-2-benzopyran, dodecahydro-3a,6,6,9a-tetramethylnaphtho[2,1b]furan, anisaldehyde, coumarin, cedrol, vanillin, cyclopentadecanolide, tricyclodecenyl acetate and tricyclodecenyl propionates.

Other fragrance materials and perfumes are essential oils, resinoids and resins from a large number of sources, such as, Peru balsam, olibanum resinoid, styrax, labdanum resin, nutmeg, cassia oil, benzoin resin, coriander, clary sage, eucalyptus, geranium, lavender, mace extract, neroli, nutmeg, spearmint, sweet violet leaf, valerian and lavandin.

Some or all of the fragrance materials and perfumes may be encapsulated, typical perfume components which it is advantageous to encapsulate, include those with a relatively low boiling point. It is also advantageous to encapsulate perfume components which have a low C log P (i.e. those which will be partitioned into water), preferably with a C log P of less than 3.0. As used herein, the term “C log P” means the calculated logarithm to base 10 of the octanol/water partition coefficient (P).

Further suitable fragrance materials and perfumes include: phenylethyl alcohol, terpineol, linalool, linalyl acetate, geraniol, nerol, 2-(1,1-dimethylethyl)cyclo-hexanol acetate, benzyl acetate, and eugenol.

The fragrance material or perfume can be used as single substance or in a mixture with one another.

Perfumes frequently include solvents or diluents, for example: ethanol, isopropanol, diethylene glycol monoethyl ether, dipropylene glycol, diethyl phthalate and triethyl citrate.

The composition may comprise from 0.01 to 10 wt % of the fragrance material or perfume based on the total weight of the composition, for instance from 0.1 to 5 wt % based on the total weight of the composition, for instance from 0.3 to 5 wt % based on the total weight of the composition.

In referring to optional ingredients, without this having to be regarded as an exhaustive description of all possibilities, which, on the other hand, are well known to the person skilled in the art, the following may be mentioned:
other products that enhance the softening performance of the composition, such as amine oxides, anionic surfactants, such as lauryl ether sulphate or lauryl sulphate, sulphosuccinates, amphoteric surfactants, such as amphoacetate, nonionic surfactants such as polysorbate, polyglucoside derivatives, and cationic polymers such as polyquaternium;
stabilising products, such as salts of amines having a short chain, which are quaternised or non-quaternised, for example of triethanolamine, N-methyldiethanolamine, and also non-ionic surfactants, such as ethoxylated fatty alcohols, ethoxylated fatty amines, polysorbate, and ethoxylated alkyl phenols; typically used at a level of from 0 to 15 wt % by weight of the composition;
products that improve viscosity control, which is preferably added when the composition comprises high concentrations of fabric conditioning active (such as the quaternary ammonium compound); for example inorganic salts, such as calcium chloride, magnesium chloride, calcium sulphate, sodium chloride; products which can be used improve the stability in concentrated compositions, such as compounds of the glycol type, such as, glycerol, polyglycerols, ethylene glycol, polyethylene glycols, dipropylene glycol, other polyglycols; and thickening agents for diluted compositions, for example, acrylamide based polymers (e.g. Flosoft® 222 from the SNF Company), hydrophobically-modified ethoxylated urethanes (e.g. Acusol 880 from the Dow Company);
components for adjusting the pH, which is preferably from 2 to 8, such as any type of inorganic and/or organic acid, for example hydrochloric, sulphuric, phosphoric, citric acid;
agents that improve soil release, such as the known polymers or copolymers based on terephthalates;
bactericidal preservative agents;
other products such as antioxidants, colouring agents, perfumes, germicides, fungicides, anti-corrosive agents, anti-crease agents, opacifiers, optical brighteners, pearl lustre agents.

The composition may further comprise at least one surfactant system. A variety of surfactants can be used in the composition of the invention, including cationic, nonionic and/or amphoteric surfactants, which are commercially available from a number of sources. For example, the composition may comprise a non-ionic surfactant which is an alkoxylated compound. The non-ionic surfactant may comprise an average of from 2 to 100 moles of alkylene oxide per mole of the nonionic surfactant. This is referred to herein as the alkoxylation number (of the non-ionic surfactant).

The composition may comprise a dye, such as an acid dye, a hydrophobic dye, a basic dye, a reactive dye, a dye conjugate. Suitable acid dyes include azine dyes such as acid blue 98, acid violet 50, and acid blue 59, non-azine acid dyes such as acid violet 17, acid black 1 and acid blue 29. Hydrophobic dyes selected from benzodifuranes, methine, triphenylmethanes, napthalimides, pyrazole, napthoquinone, anthraquinone and mono-azo or di-azo dye chromophores. Suitable hydrophobic dyes are those dyes which do not contain any charged water solubilising group. The hydrophobic dyes may be selected from the groups of disperse and solvent dyes. Blue and violet anthraquinone and mono-azo dye are preferred. Basic dyes are organic dyes which carry a net positive charge. They deposit onto cotton. They are of particular utility for used in composition that contain predominantly cationic surfactants. Dyes may be selected from the basic violet and basic blue dyes listed in the Colour Index International. Preferred examples include triarylmethane basic dyes, methane basic dye, anthraquinone basic dyes, basic blue 16, basic blue 65, basic blue 66, basic blue 67, basic blue 71, basic blue 159, basic violet 19, basic violet 35, basic violet 38, basic violet 48; basic blue 3, basic blue 75, basic blue 95, basic blue 122, basic blue 124, basic blue 141. Reactive dyes are dyes which contain an organic group capable of reacting with cellulose and linking the dye to cellulose with a covalent bond. Preferably the reactive group is hydrolysed or reactive group of the dyes has been reacted with an organic species such as a polymer, so as to the link the dye to this species. Particularly preferred dyes are: direct violet 7, direct violet 9, direct violet 11, direct violet 26, direct violet 31, direct violet 35, direct violet 40, direct violet 41, direct violet 51, direct violet 99, acid blue 98, acid violet 50, acid blue 59, acid violet 17, acid black 1, acid blue 29, solvent violet 13, disperse violet 27 disperse violet 26, disperse violet 28, disperse violet 63, disperse violet 77 and mixtures thereof.

The composition may comprise an antimicrobial. The antimicrobial may be a halogenated material. Suitable halogenated materials include 5-chloro-2-(2,4-dichlorophenoxy)phenol, o-Benzyl-p-chloro-phenol, and 4-chloro-3-methylphenol. Alternatively The antimicrobial may be a non-halogenated material. Suitable non-halogenated materials include 2-Phenylphenol and 2-(1-Hydroxy-1-methylethyl)-5-methylcyclohexanol. Phenyl ethers are one preferred sub-set of the antimicrobials. The antimicrobial may also be a bi-halogenated compound. Most preferably this comprises 4-4′ dichloro-2-hydroxy diphenyl ether, and/or 2,2-dibromo-3-nitrilopropionamide (DBNPA).

The composition may also comprise preservatives. Preferably only those preservatives that have no, or only slight, skin sensitizing potential are used. Examples are phenoxy ethanol, 3-iodo-2-propynylbutyl carbamate, sodium N-(hydroxymethyl)glycinate, biphenyl-2-ol as well as mixtures thereof.

The composition may also comprise antioxidants to prevent undesirable changes caused by oxygen and other oxidative processes to the solid composition and/or to the treated textile fabrics. This class of compounds includes, for example, substituted phenols, hydroquinones, pyrocatechols, aromatic amines and vitamin E.

The composition may comprise a polymeric thickening agent. Suitable polymeric thickening agents are water soluble or dispersable. Monomers of the polymeric thickening agent may be non-ionic, anionic or cationic. Following is a non-restrictive list of monomers performing a nonionic function: acrylamide, methacrylamide, N-Alkyl acrylamide, N-vinyl pyrrolidone, N-vinyl formamide, N-vinyl acetamide, vinylacetate, vinyl alcohol, acrylate esters, allyl alcohol. Following is a non-restrictive list of monomers performing an anionic function: acrylic acid, methacrylic acid, itaconic acid, crotonic acid, maleic acid, fumaric acid, as well as monomers performing a sulfonic acid or phosphonic acid functions, such as 2-acrylamido-2-methyl propane sulfonic acid (ATBS). The monomers may also contain hydrophobic groups. Suitable cationic monomers are selected from the group consisting of the following monomers and derivatives and their quaternary or acid salts: dimethylaminopropylmethacrylamide, dimethylaminopropylacrylamide, diallylamine, methyldiallylamine, dialkylaminoalkyl-acrylates and methacrylates, dialkylaminoalkyl-acrylamides or -methacrylamides.

Polymeric thickening agents particularly useful in the composition of the invention include those described in WO2010/078959. These are crosslinked water swellable cationic copolymers having at least one cationic monomer and optionally other nonionic and/or anionic monomers. Preferred polymers of this type are copolymers of acrylamide and trimethylaminoethylacrylate chloride.

The composition of the present invention may optionally contain an oily sugar derivative. An oily sugar derivative is a liquid or soft solid derivative of a cyclic polyol (CPE) or of a reduced saccharide (RSE), said derivative resulting from 35 to 100% of the hydroxyl groups in said polyol or in said saccharide being esterified or etherified. The derivative has two or more ester or ether groups independently attached to a C₈-C₂₂ alkyl or alkenyl chain.

Advantageously, the CPE or RSE does not have any substantial crystalline character at 20° C. Instead it is preferably in a liquid or soft solid state as herein defined at 20° C.

The liquid or soft solid (as hereinafter defined) CPEs or RSEs suitable for use in the present invention result from 35 to 100% of the hydroxyl groups of the starting cyclic polyol or reduced saccharide being esterified or etherified with groups such that the CPEs or RSEs are in the required liquid or soft solid state. These groups typically contain unsaturation, branching or mixed chain lengths.

Typically the CPEs or RSEs have 3 or more ester or ether groups or mixtures thereof, for example 3 to 8, especially 3 to 5. It is preferred if two or more of the ester or ether groups of the CPE or RSE are independently of one another attached to a C₈ to C₂₂ alkyl or alkenyl chain. The C₈ to C₂₂ alkyl or alkenyl groups may be branched or linear carbon chains.

Preferably 35 to 85% of the hydroxyl groups, most preferably 40-80%, even more preferably 45-75%, such as 45-70% are esterified or etherified.

Preferably the CPE or RSE contains at least 35% tri or higher esters, e.g. at least 40%.

The CPE or RSE has at least one of the chains independently attached to the ester or ether groups having at least one unsaturated bond. This provides a cost effective way of making the CPE or RSE a liquid or a soft solid. It is preferred if predominantly unsaturated fatty chains, derived from, for example, rape oil, cotton seed oil, soybean oil, oleic, tallow, palmitoleic, linoleic, erucic or other sources of unsaturated vegetable fatty acids, are attached to the ester/ether groups.

These chains are referred to below as the ester or ether chains (of the CPE or RSE).

The ester or ether chains of the CPE or RSE are preferably predominantly unsaturated. Preferred CPEs or RSEs include sucrose tetratallowate, sucrose tetrarapeate, sucrose tetraoleate, sucrose tetraesters of soybean oil or cotton seed oil, cellobiose tetraoleate, sucrose trioleate, sucrose triapeate, sucrose pentaoleate, sucrose pentarapeate, sucrose hexaoleate, sucrose hexarapeate, sucrose triesters, pentaesters and hexaesters of soybean oil or cotton seed oil, glucose tiroleate, glucose tetraoleate, xylose trioleate, or sucrose tetra-, tri-, penta- or hexa-esters with any mixture of predominantly unsaturated fatty acid chains. The most preferred CPEs or RSEs are those with monounsaturated fatty acid chains, i.e. where any polyunsaturation has been removed by partial hydrogenation. However some CPEs or RSEs based on polyunsaturated fatty acid chains, e.g. sucrose tetralinoleate, may be used provided most of the polyunsaturation has been removed by partial hydrogenation.

The most highly preferred liquid CPEs or RSEs are any of the above but where the polyunsaturation has been removed through partial hydrogenation. Preferably 40% or more of the fatty acid chains contain an unsaturated bond, more preferably 50% or more, most preferably 60% or more. In most cases 65% to 100%, e.g. 65% to 95% contain an unsaturated bond.

CPEs are preferred for use with the present invention. Inositol is a preferred example of a cyclic polyol. Inositol derivatives are especially preferred.

In the context of the present invention, the term cyclic polyol encompasses all forms of saccharides. Indeed saccharides are especially preferred for use with this invention. Examples of preferred saccharides for the CPEs or RSEs to be derived from are monosaccharides and disaccharides.

Examples of monosaccharides include xylose, arabinose, galactose, fructose, sorbose and glucose. Glucose is especially preferred. Examples of disaccharides include maltose, lactose, cellobiose and sucrose. Sucrose is especially preferred. An example of a reduced saccharide is sorbitan.

The liquid or soft solid CPEs can be prepared by methods well known to those skilled in the art. These include acylation of the cyclic polyol or reduced saccharide with an acid chloride; trans-esterification of the cyclic polyol or reduced saccharide fatty acid esters using a variety of catalysts; acylation of the cyclic polyol or reduced saccharide with an acid anhydride and acylation of the cyclic polyol or reduced saccharide with a fatty acid.

It is preferred if the CPE or RSE has 3 or more, preferably 4 or more ester or ether groups. If the CPE is a disaccharide it is preferred if the disaccharide has 3 or more ester or ether groups. Particularly preferred CPEs are esters with a degree of esterification of 3 to 5, for example, sucrose tri, tetra and penta esters.

Where the cyclic polyol is a reducing sugar it is advantageous if each ring of the CPE has one ether or ester group, preferably at the C₁ position. Suitable examples of such compounds include methyl glucose derivatives.

Examples of suitable CPEs include esters of alkyl(poly)glucosides, in particular alkyl glucoside esters having a degree of polymerisation from 1 to 2.

The length of the unsaturated (and saturated if present) chains in the CPE or RSE is C₈-C₂₂, preferably C₁₂-C₂₂. It is possible to include one or more chains of C₁-C₈, however these are less preferred.

The liquid or soft solid CPEs or RSEs which are suitable for use in the present invention are characterised as materials having a solid:liquid ratio of between 50:50 and 0:100 at 20° C. as determined by T₂ relaxation time NMR, preferably between 43:57 and 0:100, most preferably between 40:60 and 0:100, such as, 20:80 and 0:100. The T₂ NMR relaxation time is commonly used for characterising solid:liquid ratios in soft solid products such as fats and margarines. For the purpose of the present invention, any component of the signal with a T₂ of less than 100 μs is considered to be a solid component and any component with T₂≥100 μs is considered to be a liquid component.

For the CPEs and RSEs, the prefixes (e.g. tetra and penta) only indicate the average degrees of esterification. The compounds exist as a mixture of materials ranging from the monoester to the fully esterified ester. It is the average degree of esterification which is used herein to define the CPEs and RSEs.

The HLB of the CPE or RSE is typically between 1 and 3.

Where present, the CPE or RSE is preferably present in the composition in an amount of 0.5 to 50 wt % by weight, based on the total weight of the composition, for instance 1 to 30 wt %, for instance 2 to 20 wt %.

The CPEs and RSEs for use in the compositions of the invention include sucrose tetraoleate, sucrose pentaerucate, sucrose tetraerucate and sucrose pentaoleate.

The composition may be prepared by procedures known by a skilled person, for example, by using procedures disclosed in PCT patent publication no. WO2015/192971.

The composition may take a variety of physical forms including solid (such as granule), liquid, liquid-gel, paste-like, foam in either aqueous or non-aqueous form, and any other suitable form known by a person skilled in the art. For better dispersibility, a preferred form of the composition is a liquid form, and preferably in the form of an aqueous dispersion in water. When in a liquid form, the composition may also be dispensed with dispensing means such as a sprayer or aerosol dispenser.

The composition usually also contains a liquid carrier, which may provide the balance of the composition. Suitable liquid carriers are selected from water, organic solvents and mixtures thereof. The liquid carrier employed in the composition is preferably water due to its low cost, safety, and environmental compatibility. Mixtures of water and organic solvent may be used. Preferred organic solvents are; monohydric alcohol, such as ethanol, propanol, iso-propanol or butanol; dihydric alcohol, such as glycol; trihydric alcohols, such as glycerol, and polyhydric (polyol) alcohols.

According to one aspect of the present invention, there is provided a composition comprising (a) from 0.5 wt % to 10 wt % of a quaternary ammonium compound; (b) from 0.05 wt % to 10 wt % of a cationic polysaccharide; (c) from 0.05 wt % to 10 wt % of a non-ionic polysaccharide; (d) from 0.1 wt % to 5 wt % of a vegitable oil, weight percentages are based on the total weight of the composition.

Notably, there is provided a composition comprising (a) from 2 wt % to 8 wt % of a quaternary ammonium compound; (b) from 0.05 wt % to 5 wt % of a cationic polysaccharide; (c) from 0.05 wt % to 5 wt % of a non-ionic polysaccharide; (d) from 1 wt % to 3 wt % of a vegetable oil; weight percentages are based on the total weight of the composition.

Method of Use

In another aspect, the present invention also concerns use of the composition described herein for treating a fabric, for example, for conditioning a fabric. The invention also concerns use of the composition described herein as a textile care agent.

In still another aspect, the present invention also provides a method for conditioning a fabric by using the composition described herein. The method notably comprises the step of contacting the composition, or a dilution thereof, with the fabric.

The composition can be used in a so-called rinse process. According to the method of the present invention, the rinse step may be a rinse cycle in an automated or non-automated washing machine. The washing machine can either be front loaded or top loaded. Alternatively, the rinse step may be a hand rinsing process, which can be performed in a container, such as a basin or bucket. Typically the composition is added during the rinse cycle of an automatic laundry machine (such as an automatic fabric washing machine). When being used in the rinse process, for example, the composition is first diluted in an aqueous rinse solution. Subsequently, the laundered fabrics which have been washed with a detergent liquor and optionally rinsed in a first inefficient rinse step (“inefficient” in the sense that residual detergent and/or soil may be carried over with the fabrics), are placed in the rinse solution.

Laundry operation in which a fabric conditioning composition is used usually involves washing fabrics with a detergent, such as a detergent liquor, removing majority of the detergent, and subsequently treating the fabrics with a rinse solution containing the fabric conditioning composition. Such use of the fabric conditioning composition in conjunction with the detergent has certain problems. In particular, fabric conditioning actives, which are unusually cationic in nature, may interact with laundry residues carried over to the rinse solution from the washing step. Such laundry residues notably include anionic surfactants which are commonly used in detergents. The interaction between the fabric conditioning actives and the carry-over laundry residues may result in a reduced conditioning effect, such as a reduced softening effect. The interaction may also lead to presence of poorly soluble flocs in the rinse solution which causes troubles to consumers. Thus, it is highly desirable that a fabric conditioning composition can universally perform under laundry conditions which may vary between territories and/or population, and which may be subject to practice of the consumers. In particular, it is highly desirable that the softening conditioning composition can perform well regardless the laundry residues have been sufficiently or insufficiently removed from the fabrics before the conditioning step.

It has been found that the composition according to the invention can provide excellent softening performance in absence of laundry residues. Also, the composition, when being used in the first rinse in which the rinse solution contains considerable amount of laundry residues, can provide superior softening effects compared to conventional fabric conditioning compositions.

Should the disclosure of any patents, patent applications, and publications which are incorporated herein by reference conflict with the description of the present application to the extent that it may render a term unclear, the present description shall take precedence.

### Examples

Materials

Quat: Di(palmiticcarboxyethyl)hydroxyethyl methyl ammonium methylsulfate; Fentacare® TEP 88 (TEP; from Solvay);

Cationic Polysaccharide 1: a guar hydroxypropyltrimonium chloride having a weight average molecular weight of below 1,500,000 Daltons;

Non-ionic Polysaccharide 1: a hydroxypropyl guar having a weight average molecular weight of between 1,500,000 and 2,500,000 Daltons and a MS of between 0.9 and 1.6;

Vegetable Oil 1: NATUREL® Sunflower Oil (SFO);

Fabrics: 100% cotton 40×70 cm HAREN® hand towels.

Procedures for Sample Preparation

The quat and the vegetable oil were weighed into a beaker and melted over a hotplate to a transparent blend at 60° C. Water at 55° C. was added into reactor. Polysaccharides mixture (cationic guar:non-ionic guar=1:3 by weight) was added to the reactor and agitation speed was set enough to disperse the polysaccharides in the water. Melted blend (quat and oil) was charged into the reactor and agitation was provided. The resulting formulations was stirred for 12 to 15 minutes with reaction temperature maintained at 55° C. Then, reaction temperature was cooled, while cooling, appropriate amounts of dyes and perfumes were added. Final pH was adjusted to 3.5-3.7 using 1M NaOH.

Fabric Treatment Under No-Laundry-Residue Condition

Water (70 L) was dispensed into the washing chamber of a Samsung top loader washing machine and 30 g of the fabric conditioning composition samples were added once water level reached ⅓ height. A total of 2.5 kg load (6 test towels, 38 g each and 8 ballast towels, 290 g each) were loaded into the chamber and it was ensured that the towels were immersed. The towels were then laundered for zero rinse one wash cycle, subsequently subject to one draining and spinning according to the program of the washing machine. The towels were dried overnight in a controlled humidity room for overnight. Then the towels were subject to softness evaluation.

Fabric Treatment in Presence of Laundry Residues

Water (47 L) was dispensed into the washing chamber of a Samsung top loader washing machine and 35 g of Breeze® powder detergent were added once water level reached ⅓ height. A total of 2.5 kg load (6 test towels, 38 g each and 8 ballast towels, 290 g each) were loaded into the chamber and it was ensured that the towels were immersed. The towels were then laundered for one rinse one wash cycle, subsequently subject to one draining and spinning according to the program of the washing machine. Then load were removed thereafter before rinse water was dispensed into the washing chamber and 47 g of the fabric conditioning composition samples were added once water level reached ⅓ height. The towels were then treated, subsequently subject to one draining and spinning according to the program of the washing machine. The towels were dried overnight in a controlled humidity room for overnight. Then the towels were subject to softness evaluation.

Fabric Softness Evaluation

Revised ASTM D5237-05 Standard was adopted for fabric softness evaluation. The softness of each treated towel was evaluated by six panellists independently, in which the panellist touched the treated towel and felt the softness. 3 rounds (first touch, second touch were conducted to generate more statistics from (n=6) to (n=18). The softness of the treated towels was rated in a scale of 1 to 5, wherein 1 represents the lowest softness and 5 represents the highest softness. A difference in +0.25 suggested slight difference, +0.50 suggested significant difference between two softness. The average softness rating of the towels in each group (n=18) was calculated.

The fabric softness evaluation results are shown in Tables 1 and 2 below:

TABLE 1
fabric treatment under no-laundry-residue condition

| Samples | Formulation (wt %) | Softness |
|---|---|---|
| Sample 1 | 6% TEP + 0.4% PS + 1% SFO | 3.97 |
| Sample 2 | 6% TEP + 0.4% PS + 3% SFO | 3.96 |
| Comparative Sample 1 | 10.5% TEP | 3.96 |
| Comparative Sample 2 | 6% TEP + 0.4% PS | 3.66 |

TABLE 2
fabric treatment in presence of laundry residue

| Samples | Formulation (wt %) | Softness |
|---|---|---|
| Sample 1 | 6% TEP + 0.4% PS + 1% SFO | 3.82 |
| Comparative Sample 1 | 10.5% TEP | 3.57 |
| Comparative Sample 2 | 6% TEP + 0.4% PS | 3.61 |
| Comparative Sample 3 | 6% TEP + 1% SFO | 3.24 |

(“PS” shown in Tables 1 and 2 refers to mixture of Cationic Polysaccharide 1 and Non-ionic Polysaccharide 1 (1:3 by weight))

It can be seen from the above results that the inventive compositions provided excellent softening performance under both conditions of fabric treatment. In particular, under the no-laundry-residue condition, the inventive compositions provided same level of softening performance as that comprising high content quat alone (10.5 wt %), while in presence of laundry residue, a marked enhancement was evident. Furthermore, the inventive compositions provided better softening performance compared to that comprising quat and polysaccharides components, or that comprising quat and vegetable oil components.

Stability Test

Samples stored at 40° C. were removed from the oven and naturally cooled to room temperature before viscosity measurements at 10 and 60 rpm were taken with a standard LV toque Brookfield Viscometer, at a basis of every 3 weeks. Observation in physical changes, such as phase separation and color changes, were recorded as indication of instability. Results are shown in Table 3 below:

TABLE 3

| | | Viscosity | Viscosity | Viscosity | Viscosity | Viscosity | Viscosity | Viscosity |
|---|---|---|---|---|---|---|---|---|
| Samples | Formulation (wt %) | (0 WK) | (6 WK) | (9 WK) | (12 WK) | (3 WK) | (16 WK) | (24 WK) |
| Sample 1 | 6% TEP + 0.4% | 637 cP | 620 cP | 639 cP | 659 cP | 486 cP | 440 cP | 483 cP |
| | PS + 1% SFO | | | | | | | |
| Comparative | 6% TEP + 0.4% | 613 cP | 535 cP | 521 cP | 437 cP | 484 cP | 478 cP | Phase |
| Sample 2 | PS | | | | | | | Separation |
| | | | | | | | | @ 21 WK |
| Comparative | 6% TEP + 1% SFO | Oil floats | NA | NA | NA | NA | NA | NA |
| Sample 3 | | on top | | | | | | |

(“PS” shown in Table 3 refers to mixture of Cationic Polysaccharide 1 and Non-ionic Polysaccharide 1 (1:3 by weight))

Results showed that the inventive composition exhibited good stability up to 16 weeks of storage without phase separation. In contrast, the composition without the polysaccharides component was phase separated, indicating poor storage stability.

1. A composition comprising (a) a quaternary ammonium compound; (b) a cationic polysaccharide; (c) a non-ionic polysaccharide; and (d) a vegetable oil.

2. The composition according to claim 1, wherein the quaternary ammonium compound is according to the general formula:
[N⁺(R₁)(R₂)(R₃)(R₄)]_{y}X⁻ (I)
wherein:
R₁, R₂, R₃ and R₄, which may be the same or different, is a C₁-C₄₀ hydrocarbon group, respectively, optionally containing a heteroatom or an ester or amide group;
X is an anion;
y is the valence of X.

3. The composition according to claim 2, wherein at least one of R₁, R₂, R₃ and R₄ as defined in general formula (I) contains an ester or amide group.

4. The composition according to claim 1, wherein the quaternary ammonium compound is according to the general formula:
[N⁺(R₅)₂(R₆)(R₇)]_{y}X⁻ (II)
wherein:
R₅ is a C₁₆-C₂₂ alkyl, alkenyl or hydroxyalkyl group;
R₆ is a C₁-C₄ alkyl, alkenyl or hydroxyalkyl group;
R₇ is R₅ or R₆;
X is an anion;
y is the valence of X.

5. The composition according to claim 1, wherein the quaternary ammonium compound is according to the general formula:
[N⁺((CH₂)ₙ-T-R)ₘ(R₉)₄₋ₘ]_{y}X⁻ (III)
R₈ is a C₁-C₂₄ alkyl, alkenyl, or hydroxylalkyl group;
R₉ is a C₁-C₄ alkyl, alkenyl, or hydroxylalkyl group;
T is —C(═O)—O—, —O—C(═O)—, —NR₁₀—C(═O)— or —(C═O)—NR₁₀—, wherein R₁₀ is hydrogen, a C₁-C₆ alkyl, alkenyl, or hydroxyalkyl group;
n is an integer from 0 to 5;
m is selected from 1, 2 and 3;
X is an anion;
y is the valence of X.

6. The composition according to claim 1, wherein the quaternary ammonium compound has the general formula:
[N⁺((CH₂)ₙ-T-R₈)₂(R₉)₂]_{y}X⁻ (IV)
R₈ is a C₁-C₂₄ alkyl, alkenyl, or hydroxylalkyl group;
R₉ is a C₁-C₄ alkyl, alkenyl, or hydroxylalkyl group;
T is —C(═O)—O—, —O—C(═O)—, —NR₁₀—C(═O)— or —(C═O)—NR₁₀—, wherein R₁₀ is hydrogen, a C₁-C₆ alkyl, alkenyl, or hydroxyalkyl group;
n is an integer from 0 to 5;
m is selected from 1, 2 and 3;
X is an anion;
y is the valence of X.

7. The composition according to claim 1, wherein the quaternary ammonium compound is selected from the group consisting of:
Di(tallowcarboxyethyl)hydroxyethyl methyl ammonium methylsulfate,
Di(oleocarboxyethyl)hydroxyethyl methyl ammonium methylsulfate,
Distearyl hydroxyethyl methyl ammonium methylsulfate,
Di(hydrogenated tallow-carboxyethyl)hydroxyethyl methyl ammonium methylsulfate,
Di(palmiticcarboxyethyl)hydroxyethyl methyl ammonium methylsulfate, and
Dimethylbis[2-[(1-oxooctadecyl)oxy]ethyl]ammonium chloride.

8. The composition according to claim 1, wherein the cationic polysaccharide is a cationic guar.

9. The composition according to claim 1, wherein the non-ionic polysaccharide is a non-ionic guar.

10. The composition according to claim 1, wherein the vegetable oil is selected from the group consisting of sunflower oil, olive oil, almond oil and a mixture thereof.

11. The composition according to claim 10, wherein the vegetable oil is sunflower oil.

12. The composition according to claim 1, wherein said composition comprises: (a) from 0.5 wt % to 10 wt % of the quaternary ammonium compound; (b) from 0.05 wt % to 10 wt % of the cationic polysaccharide; (c) from 0.05 wt % to 10 wt % of the non-ionic polysaccharide; (d) from 0.1 wt % to 5 wt % of the vegetable oil, weight percentages are based on the total weight of the composition.

13. The composition according to claim 1, wherein said composition comprises: (a) from 2 wt % to 8 wt % of the quaternary ammonium compound; (b) from 0.05 wt % to 5 wt % of the cationic polysaccharide; (c) from 0.05 wt % to 5 wt % of the non-ionic polysaccharide; (d) from 1 wt % to 3 wt % of the vegetable oil; weight percentages are based on the total weight of the composition.

14. The composition according to claim 1, wherein said composition further comprises a fragrance material or perfume.

15. (canceled)

16. A method for conditioning a fabric, comprising the step of contacting said fabric with the composition according to claim 1 or a dilution thereof.
